(19) United States
(12) Patent Application Publication
(10) Pub. No.: US 2016/0298723 A1
(43) Pub. Date: Oct. 13, 2016

(54) FLYWHEEL

(71) Applicant: TOYOTA JIDOSHA KABUSHIKI KAISHA, Toyota-shi (JP)

(72) Inventor: Amane SHIMURA, Anjo-shi (JP)

(73) Assignee: TOYOTA JIDOSHA KABUSHIKI KAISHA, Toyota-shi (JP)

(21) Appl. No.: 15/091,719

(22) Filed: Apr. 6, 2016

(30) Foreign Application Priority Data
Apr. 7, 2015 (JP) 2015-078553

(51) Int. Cl. F16F 15/30

(52) U.S. Cl. CPC F16F 15/30

(57) ABSTRACT

A flywheel that has a flywheel main body and an inertia ring is provided. The flywheel main body has a disc-like shape. The inertia ring (i) has an annular shape, (ii) has a plurality of fastening portions, (iii) is fastened to the flywheel main body by the fastening portions, (iv) has a plurality of notches provided spaced apart in a circumferential direction of the inertia ring, in at least one of an inner peripheral surface or an outer peripheral surface of the inertia ring, and (v) has at least one of the fastening portions at each portion that is positioned between the notches.

### INCORPORATION BY REFERENCE

The disclosure of Japanese Patent Application No. 2015-078553 filed on Apr. 7, 2015 including the specification, drawings and abstract is incorporated herein by reference in its entirety.

### BACKGROUND OF THE INVENTION

1. Field of the Invention

The invention relates to a flywheel provided with an inertia ring.

2. Description of Related Art

Japanese Patent Application Publication No. 10-227337 (JP 10-227337 A) describes a flywheel in which an inertia ring for adjusting the amount of inertia is fixed to a flywheel main body. The inertia ring is provided in an annular shape, and has plurality of through-holes through which bolts are to be inserted provided spaced apart in a circumferential direction. Also, a plurality of bolt insertion holes through which the bolts that have been inserted through the through-holes in the inertia ring are to be inserted, are provided in the flywheel main body. With the flywheel described in JP 10-227337 A, the inertia ring is fixed to the flywheel main body by inserting the bolts through the through-holes in the inertia ring, and then inserting the bolts into the insertion holes in the flywheel main body.

When the flywheel rotates, centrifugal force acts on the inertia ring. Therefore, although it does not normally occur, if the rotation speed of the flywheel were to become excessively high, excessive stress may be generated in the inertia ring due to the centrifugal force, and the inertia ring may break (i.e., fracture) from the stress. If the inertia ring breaks, fragments of the inertia ring may end up separating from the flywheel main body.

### SUMMARY OF THE INVENTION

In view of this, the invention provides a flywheel in which even if the inertia ring break, fragments of the inertia ring will not easily separate from the flywheel main body.

Thus, a first aspect of the invention relates to a flywheel that includes a flywheel main body and an inertia ring. The flywheel main body has a disc-like shape. The inertia ring (i) has an annular shape, (ii) has a plurality of fastening portions, (iii) is fastened to the flywheel main body by the fastening portions, (iv) has a plurality of notches provided spaced apart in a circumferential direction of the inertia ring, in at least one of an inner peripheral surface or an outer peripheral surface of the inertia ring, and (v) has at least one of the fastening portions at each portion that is positioned between the notches.

As described above, with this structure of the flywheel, although it does not normally occur, if the rotation speed of the flywheel were to become excessively high, excessive stress may be generated in the inertia ring due to centrifugal force. In such a case, stress tends to concentrate at the portions where the notches are provided. Therefore, even if the inertia ring were to fracture, the portions where the notches are provided would fracture. That is, the portion where the inertia ring fractures is able to be controlled to the portion where the notches are positioned. Here, there is always a fastening portion at the portion positioned between circumferentially adjacent notches. Therefore, even if the inertia ring were to fracture and break apart, there will tend to be a fastening portion that fastens the inertia ring to the flywheel at each of the broken fragments. Thus, the fragment of the inertia ring will not easily separate from the flywheel main body.

In the flywheel described above, each of the notches may have a wedge shape that becomes narrower farther away from the peripheral surface in which the notch is provided. According to this structure of the flywheel, stress tends to concentrate at the bottom portions of the notches, i.e., at the tip end portions of the wedges, so the position where the inertia ring fractures is able to be more precisely controlled.

In the flywheel described above, a plurality of the notches may be provided in each of the inner peripheral surface and the outer peripheral surface of the inertia ring. Also, the notches provided in the inner peripheral surface of the inertia ring, and the notches provided in the outer peripheral surface of the inertia ring may be provided in pairs, with one of the notches provided in the inner peripheral surface and one of the notches provided in the outer peripheral surface making up one pair, and the two notches in each pair being in the same position in the circumferential direction of the inertia ring. Further, the notches provided in the inner peripheral surface of the inertia ring, and the notches provided in the outer peripheral surface of the inertia ring may be provided appearing alternately in the circumferential direction of the inertia ring.

As described above, with this structure of the flywheel, the inertia ring tends to fracture in a manner in which notches that form a pair, one on the inner peripheral surface side and the other on the outer peripheral surface side, will become connected. That is, the shape and size of the fragment of the inertia ring are able to be more precisely controlled.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 front view of a flywheel according to a first example embodiment of the invention;

FIG. 2 is a sectional view taken along line II-II in FIG. 1;

FIG. 3 front view of a flywheel according to a second example embodiment of the invention;

FIG. 4 front view of a flywheel according to a third example embodiment of the invention;

FIG. 5 front view of a flywheel according to a fourth example embodiment of the invention; and

FIG. 6 front view of a flywheel according to a fifth example embodiment of the invention.

### DETAILED DESCRIPTION OF EMBODIMENTS

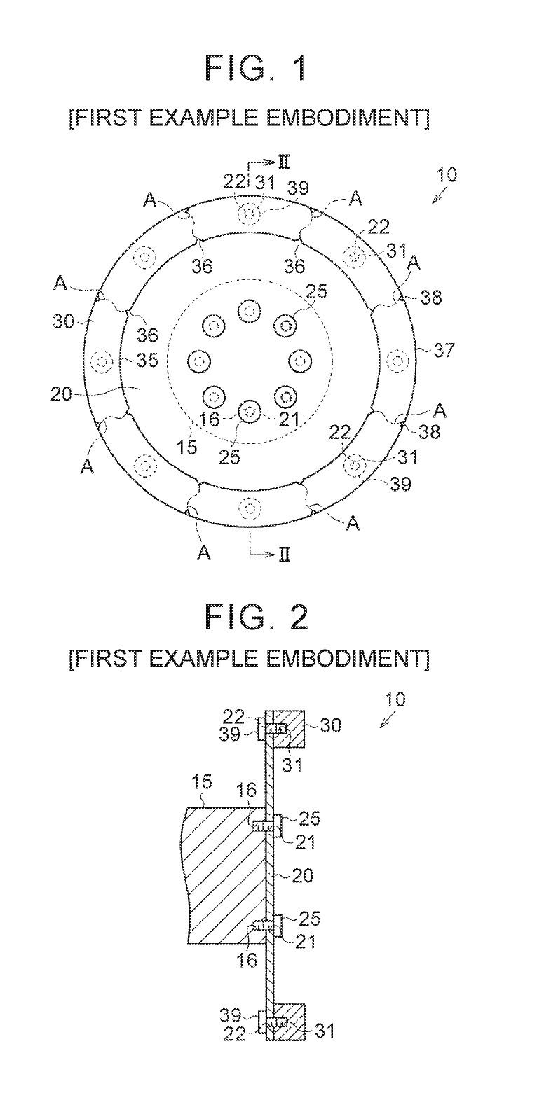

Hereinafter, a flywheel according to a first example embodiment of the invention will be described with reference to FIGS. 1 and 2. As shown in FIGS. 1 and 2, a flywheel 10 of the first example embodiment includes a disc-like flywheel main body 20 and an annular inertia ring 30.

The flywheel main body 20 is made of ferrous metal, for example. Eight first through-holes 21 are provided in the flywheel main body 20. These first through-holes 21 are provided at equally-spaced intervals in a circumferential direction. Also, eight second through-holes 22 are provided in portions to a radially outer side of the portion where the first through-holes 21 are provided. These second through-holes 22 are provided at equally-spaced intervals in the circumferential direction.

As shown in FIG. 2, the flywheel main body 20 is fixed to a crankshaft 15 of an internal combustion engine by eight bolts 25. Eight insertion holes 16 for inserting the eight bolts 25 are provided in the crankshaft 15, in locations corresponding to eight the first through-holes 21. In the front view in FIG. 1, the eight first through-holes 21 in the flywheel main body 20 and the eight insertion holes 16 in the crankshaft 15 are overlapping each other, so these are indicated by the same broken lines. An internal thread is provided on an inner peripheral surface of each insertion hole 16 in the crankshaft 15. Therefore, the flywheel main body 20 is fastened to the crankshaft 15 by inserting the bolts 25 first through the first through-holes 21 in the flywheel main body 20 and then through the insertion holes 16 in the crankshaft 15, and then screwing the bolts 25 into the internal threads in the insertion holes 16, as shown in FIG. 2.

The inertia ring 30 is made of ferrous metal, and is provided by casting or machining. As described above, the inertia ring 30 has an annular shape. Also, an outer diameter of the inertia ring 30 is approximately the same length as the diameter of the flywheel main body 20, as shown in FIG. 1, and the thickness of the inertia ring 30 is thicker than the thickness of the flywheel main body 20, as shown in FIG. 2.

Eight insertion holes 31 are provided in the inertia ring 30, in locations corresponding to the eight second through-holes 22 in the flywheel main body 20. That is, the insertion holes 31 are provided at equally-spaced intervals in the circumferential direction, in the inertia ring 30. As shown in FIG. 2, the insertion holes 31 are provided in a surface of the inertia ring 30 that is on the left in FIG. 2, and do not pass through the inertia ring 30. An internal thread is provided on an inner peripheral surface of each insertion hole 31. In the front view in FIG. 1, the eight insertion holes 31 in the inertia ring 30 overlap with the eight second through-holes 22 in the flywheel main body 20, so these are indicated by the same broken lines.

As shown in FIG. 1, eight notches 36 are provided at equally-spaced intervals separated in the circumferential direction, in an inner peripheral surface 35 of the inertia ring 30. Also, eight notches 38 are provided at equally-spaced intervals separated in the circumferential direction, in an outer peripheral surface 37 of the inertia ring 30. As shown in FIG. 1, the notches 36 and 38 are wedge shaped, becoming narrower toward the deeper portion in a front view. Also, the notches 36 and 38 are provided through from one of two surfaces that are perpendicular to the thickness direction of the inertia ring 30 (i.e., a direction orthogonal to the sheet of paper on which FIG. 1 is drawn) to the other. That is, the notches 36 and 38 are provided through the entire thickness direction of the inertia ring 30.

Also, as shown in FIG. 1, the eight notches 36 provided in the inner peripheral surface 35 of the inertia ring 30, and the eight notches 38 provided in the outer peripheral surface 37 are provided in pairs, with one notch 36 and one notch 38 making up one pair, and the two notches 36 and 38 in each pair being in the same position in the circumferential direction of the inertia ring 30. Each pair of notches 36 and 38 is positioned between two adjacent insertion holes 31. Therefore, with the inertia ring 30, there is one insertion hole 31 for each portion that is positioned between circumferentially adjacent notches 36. Also, with the inertia ring 30, there is one insertion hole 31 for each portion that is positioned between circumferentially adjacent notches 38.

As shown in FIG. 2, the inertia ring 30 is fixed to the flywheel main body 20 by bolts 39. More specifically, the bolts 39 are inserted through the second through-holes 22 in the flywheel main body 20 and into the insertion holes 31 in the inertia ring 30, in this order, and screwed together with the internal threads in the insertion holes 31. As a result, the inertia ring 30 and the flywheel main body 20 are fastened together. Accordingly, with the inertia ring 30, there is one portion fastened by one of the bolts 39, for each portion that is positioned between the notches 36 provided apart in the circumferential direction. Also, when illustrated by the relationship between the position where the notches 38 are provided and the position of the fastening portion, with the inertia ring 30, there is one portion fastened by one of the bolts 39, for each portion that is provided between the notches 38 that are provided apart in the circumferential direction.

Next, operation of the first example embodiment will be described. When the crankshaft 15 is rotated, the flywheel 10 rotates, so centrifugal force acts on the inertia ring 30. Also, although it does not normally occur, if the rotation speed of the flywheel were to become excessively high, excessive stress may be generated in the inertia ring 30 due to the centrifugal force. In such a case, stress tends to concentrate at the portions where the notches 36 and 38 are provided. Therefore, even if the inertia ring 30 were to fracture due to the flywheel 10 rotating at a high speed, the inertia ring 30 would fracture at the portions where the notches 36 and 38 are provided in pairs, as indicated by the alternate long and two short dashes lines A in FIG. 1.

Here, if the inertia ring 30 were to fracture in a plurality of locations separated in the circumferential direction, the inertia ring 30 would end up breaking up into a plurality of pieces. However, as shown by the alternate long and two short dashes lines A in FIG. 1, as long as the inertia ring 30 fractures at the portions where the notches 36 and 38 are provided in pairs, then even if the inertia ring 30 breaks up into several pieces, there is a portion fastened by one of the bolts 39 at each of these pieces. Therefore, the piece of the inertia ring 30 that has broken off will be held to the flywheel main body 20.

Therefore, with the first example embodiment, the operation and effects described below are able to be displayed. (1) With the flywheel 10, even if excessive stress is generated in the inertia ring 30 by centrifugal force and the inertia ring 30 fractures, fragments of the inertia ring 30 are able to be inhibited from separating from the flywheel main body 20.

(2) With the flywheel 10, each of the notches 36 and 38 of the inertia ring 30 are wedge shaped, becoming narrower toward the deeper portion. Therefore, stress tends to concentrate at the bottom portions of the notches 36 and 38, at the tip end portions of the wedges, so the position where the inertia ring 30 breaks is able to be more precisely controlled.

(3) With the flywheel 10, the pluralities of the notches 36 and 38 are provided in the inner peripheral surface 35 and the outer peripheral surface 37, respectively, of the inertia ring 30, and the notches 36 provided in the inner peripheral surface 35 of the inertia ring 30, and the notches 38 provided in the outer peripheral surface 37 of the inertia ring 30 are provided in pairs, with one notch 36 and one notch 38 making up one pair, and the two notches 36 and 38 in each pair being in the same position in the circumferential direction of the inertia ring 30. Therefore, the inertia ring 30 will tend to fracture in a manner in which the notches 36 and 38 that form a pair, one on the inner peripheral surface 35 side and the other on the outer peripheral surface 37 side, will become connected, as indicated by the alternate long and two short dashes lines A in FIG. 1. That is, the shape and size of the fragment of the inertia ring 30 are able to be more precisely controlled.

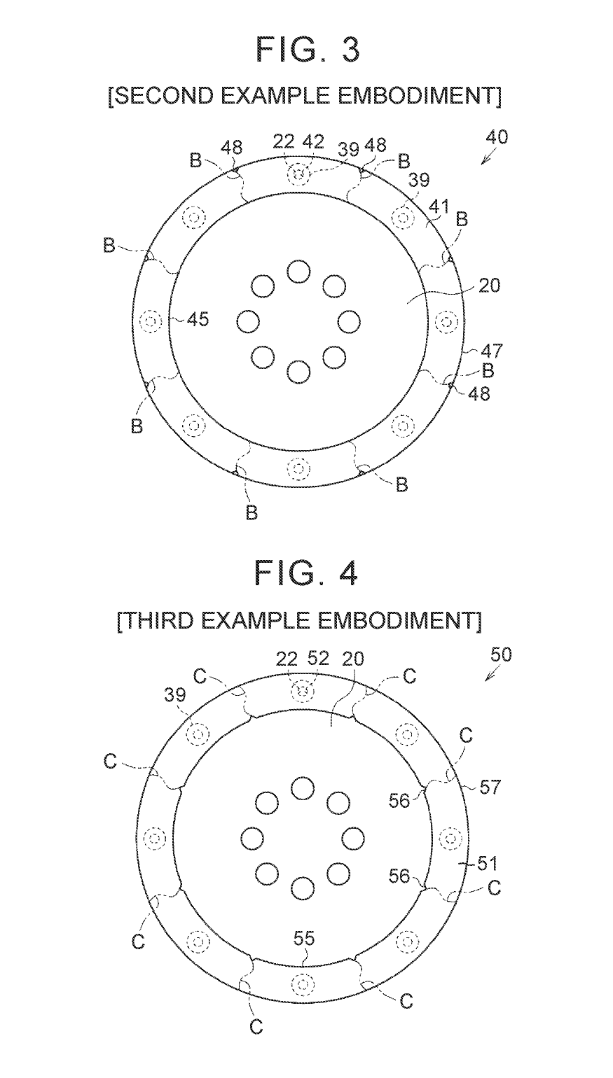

Next, a flywheel according to a second example embodiment of the invention will be described with reference to FIG. 3. Descriptions of structure that is the same as that in the first example embodiment will be omitted as appropriate.

As shown in FIG. 3, a flywheel 40 according to the second example embodiment includes a flywheel main body 20 having a structure similar to that of the flywheel main body 20 according to the first example embodiment, and an inertia ring 41 having a structure that differs from that of the inertia ring 30 according to the first example embodiment.

In this second example embodiment, notches are not provided in an inner peripheral surface 45 of the inertia ring 41, but notches 48 are provided in an outer peripheral surface 47. More specifically, eight notches 48 are provided at equally-spaced intervals apart in the circumferential direction, in the outer peripheral surface 47 of the inertia ring 41. The shape of these notches 48 is the same shape as the notches 38 in the first example embodiment, i.e., the notches 48 have a wedge shape that becomes narrower toward the deeper portion in a front view. These notches 48 are provided along the entire thickness direction of the inertia ring 41. Also, there is one insertion hole 42 (a fastening portion to fasten the inertia ring 41 to the flywheel main body 20) for the bolt 39, in each portion of the inertia ring 41 that is positioned between circumferentially adjacent notches 48. An internal thread is provided on an inner peripheral surface of each insertion hole 42. Also, the inertia ring 41 is fastened to the flywheel main body 20 by the bolts 39 being inserted through the second through-holes 22 in the flywheel main body 20 and into the insertion holes 42 in the inertia ring 41, in this order, and screwed together with the internal threads in the insertion holes 42.

In this second example embodiment, although it does not normally occur, if the rotation speed of the flywheel 40 were to become excessively high, excessive stress may be generated in the inertia ring 41 due to centrifugal force. In such a case, stress tends to concentrate at the portions where the notches 48 are provided. Therefore, even if the inertia ring 41 were to fracture due to the flywheel 40 rotating at a high speed, the portions where the notches 48 are provided would fracture, as shown by the alternate long and two short dashes lines B in FIG. 2. That is, the portion where the inertia ring 41 fractures is able to be controlled to the portion where the notches 48 are positioned. As a result, in the second example embodiment as well, operation and effects similar to those in (1) and (2) in the first example embodiment are able to be displayed.

Next, a flywheel according to a third example embodiment of the invention will be described with reference to FIG. 4. Descriptions of structure that is the same as that in the first example embodiment will be omitted as appropriate.

As shown in FIG. 4, a flywheel 50 according to the third example embodiment includes a flywheel main body 20 having a structure similar to that of the flywheel main body 20 according to the first example embodiment, and an inertia ring 51 having a structure that differs from that of the inertia ring 30 according to the first example embodiment.

In this third example embodiment, notches 56 are provided in an inner peripheral surface 55 of the inertia ring 51, but notches are not provided in an outer peripheral surface 57. More specifically, eight notches 56 are provided at equally-spaced intervals apart in the circumferential direction in the inner peripheral surface 55 of the inertia ring 51. The shape of these notches 56 is the same shape as the notches 36 in the first example embodiment, i.e., the notches 56 have a wedge shape that becomes narrower toward the deeper portion in a front view. These notches 56 are provided along the entire thickness direction of the inertia ring 51. Also, there is one insertion hole 52 (a fastening portion to fasten the inertia ring 51 to the flywheel main body 20) for the bolt 39, in each portion of the inertia ring 51 that is positioned between circumferentially adjacent notches 56. An internal thread is provided on an inner peripheral surface of each insertion hole 52. Also, the inertia ring 51 is fastened to the flywheel main body 20 by the bolts 39 being inserted through the second through-holes 22 in the flywheel main body 20 and into the insertion holes 52 in the inertia ring 51, in this order, and screwed together with the internal threads in the insertion holes 52.

In this third example embodiment, although it does not normally occur, if the rotation speed of the flywheel 50 were to become excessively high, excessive stress may be generated in the inertia ring 51 due to centrifugal force. In such a case, stress tends to concentrate at the portions where the notches 56 are provided. Therefore, even if the inertia ring 51 were to fracture due to the flywheel 50 rotating at a high speed, the portions where the notches 56 are provided would fracture, as shown by the alternate long and two short dashes lines C in FIG. 4. That is, the portion where the inertia ring 51 fractures is able to be controlled to the portion where the notches 56 are positioned. As a result, in the third example embodiment as well, operation and effects similar to those in (1) and (2) in the first example embodiment are able to be displayed.

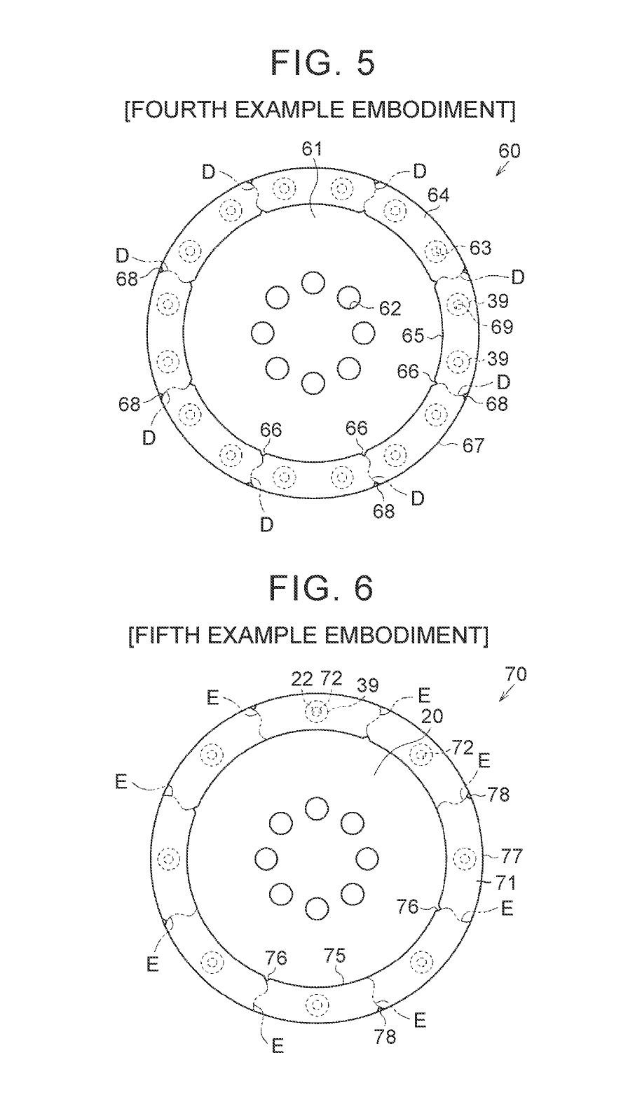

Next, a flywheel according to a fourth example embodiment of the invention will be described with reference to FIG. 5. Descriptions of structure that is the same as that in the first example embodiment will be omitted as appropriate.

As shown in FIG. 5, a flywheel 60 according to the fourth example embodiment includes a flywheel main body 61 having a structure that differs from that of the flywheel main body 20 according to the first example embodiment, and an inertia ring 64 having a structure that differs from that of the inertia ring 30 according to the first example embodiment.

In this fourth example embodiment, notches 66 are provided in an inner peripheral surface 65 of the inertia ring 64, and notches 68 are provided in an outer peripheral surface 67. More specifically, eight notches 66 are provided at equally-spaced intervals apart in the circumferential direction in the inner peripheral surface 65 of the inertia ring 64. The shape of these notches 66 is the same shape as the notches 36 in the first example embodiment, i.e., the notches 66 have a wedge shape that becomes narrower toward the deeper portion in a front view. These notches 66 are provided along the entire thickness direction of the inertia ring 64. Also, eight notches 68 are provided at equally-spaced intervals apart in the circumferential direction in the outer peripheral surface 67 of the inertia ring 64. The shape of these notches 68 that are provided in the outer peripheral surface 67 is the same shape as the notches 38 in the first example embodiment, i.e., the notches 68 have a wedge shape that becomes narrower toward the deeper portion in a front view. These notches 68 are provided along the entire thickness direction of the inertia ring 64. Also, the notches 66 provided in the inner peripheral surface 65 of the inertia ring 64, and the notches 68 provided in the outer peripheral surface 67 of the inertia ring 64 are provided in pairs, with one notch 66 and one notch 68 making up one pair, and the two notches 66 and 68 in each pair being in the same position in the circumferential direction of the inertia ring 64.

Also, with the inertia ring 64, two insertion holes 69 for bolts 39 are provided in each portion that is positioned between circumferentially adjacent notches 66, in the inner peripheral surface 65 of the inertia ring 64. Therefore, two of the insertion holes 69 for the bolts 39 are also provided in each portion that is positioned between circumferentially adjacent notches 68, in the outer peripheral surface 67 of the inertia ring 64. Internal threads are provided on the inner peripheral surface of each insertion hole 69.

Sixteen second through-holes 63 are provided corresponding to these insertion holes 69, in the flywheel main body 61. Therefore, in FIG. 5, the insertion holes 69 in the inertia ring 64 and the second through-holes 63 in the flywheel main body 61 are indicated by the same broken lines. The inertia ring 64 and the flywheel main body 61 are fastened together by the bolts 39 being inserted through the second through-holes 63 in the flywheel main body 61 and into the insertion holes 69 in the inertia ring 64, in this order, and screwed together with the internal threads in the insertion holes 69. That is, in the inertia ring 64, there are two bolt fastening portions that fasten to the flywheel main body 61, between circumferentially adjacent notches 66 in the inner peripheral surface 65 of the inertia ring 64, and between circumferentially adjacent notches 68 in the outer peripheral surface 67 of the inertia ring 64. First through-holes 62 for fixing the flywheel main body 61 to the crankshaft are provided in the same manner as the first through-holes 21 of the first example embodiment.

In this fourth example embodiment, although it does not normally occur, if the rotation speed of the flywheel 60 were to become excessively high, excessive stress may be generated in the inertia ring 64 due to centrifugal force. In such a case, stress tends to concentrate at the portions where the notches 66 and 68 are provided. Therefore, even if the inertia ring 64 were to fracture due to the flywheel 60 rotating at a high speed, the portions where the notches 66 and 68 are provided would fracture, as shown by the alternate long and two short dashes lines D in FIG. 5. That is, the portion where the inertia ring 64 fractures is able to be controlled to the portion where the notches 66 and 68 are positioned. As a result, in the fourth example embodiment as well, operation and effects similar to those in (1) and (2) in the first example embodiment are able to be displayed.

Next, a flywheel according to a fifth example embodiment of the invention will be described with reference to FIG. 6. Descriptions of structure that is the same as that in the first example embodiment will be omitted as appropriate.

As shown in FIG. 6, a flywheel 70 according to the fifth example embodiment includes a flywheel main body 20 having a structure similar to that of the flywheel main body 20 according to the first example embodiment, and an inertia ring 71 having a structure that differs from that of the inertia ring 30 according to the first example embodiment.

In this fifth example embodiment, notches 76 are provided in an inner peripheral surface 75 of the inertia ring 71, and notches 78 are provided in an outer peripheral surface 77. More specifically, four notches 76 are provided at equally-spaced intervals apart in the circumferential direction in the inner peripheral surface 75 of the inertia ring 71. The shape of these notches 76 is the same as the shape of the notches 36 in the first example embodiment, i.e., the notches 76 have a wedge shape that becomes narrower toward the deeper portion in a front view. These notches 76 are provided along the entire thickness direction of the inertia ring 71. Also, four notches 78 are provided at equally-spaced intervals apart in the circumferential direction in the outer peripheral surface 77 of the inertia ring 71. The shape of these notches 78 that are provided in the outer peripheral surface 77 is the same as the shape of the notches 38 in the first example embodiment, i.e., the notches 78 have a wedge shape that becomes narrower toward the deeper portion in a front view. These notches 78 are provided along the entire thickness direction of the inertia ring 71. Also, the notches 76 provided in the inner peripheral surface 75 of the inertia ring 71, and the notches 78 provided in the outer peripheral surface 77 of the inertia ring 71 are provided in different positions in the circumferential direction of the inertia ring 71.

Eight insertion holes 72 are provided corresponding to the second through-holes 22 in the flywheel main body 20, in the inertia ring 71. That is, the insertion holes 72 are provided at equally-spaced intervals in the circumferential direction in the inertia ring 71. With the inertia ring 71, the notches 76 and the notches 78 are provided appearing alternately in the circumferential direction, in portions positioned between circumferentially adjacent insertion holes 72. Two of the insertion holes 72 for the bolts 39 are provided in each portion that is positioned between circumferentially adjacent notches 76 in the inner peripheral surface 75 of the inertia ring 71. Two of the insertion holes 72 for the bolts 39 are also provided in each portion that is positioned between circumferentially adjacent notches 78 in the outer peripheral surface 77 of the inertia ring 71. Internal threads are formed on the inner peripheral surfaces of the insertion holes 72.

Also, the inertia ring 71 and the flywheel main body 20 are fastened together by the bolts 39 being inserted through the second through-holes 22 in the flywheel main body 20 and into the insertion holes 72 in the inertia ring 71, in this order, and screwed together with the internal threads in the insertion holes 72. That is, in the inertia ring 71, there are two bolt fastening portions that fasten the inertia ring 71 to the flywheel main body 20 between each pair of circumferentially adjacent notches 76 in the inner peripheral surface 75 of the inertia ring 71, and between each pair of the circumferentially adjacent notches 78 in the outer peripheral surface 77 of the inertia ring 71.

In this fifth example embodiment, although it does not normally occur, if the rotation speed of the flywheel 70 were to become excessively high, excessive stress may be generated in the inertia ring 71 due to centrifugal force. In such a case, stress tends to concentrate at the portions where the notches 76 and 78 are provided. Therefore, even if the inertia ring 71 were to fracture due to the flywheel 70 rotating at a high speed, the portions where the notches 76 and 78 are provided would fracture, as shown by the alternate long and two short dashes lines E in FIG. 6. That is, the portion where the inertia ring 71 fractures is able to be controlled to the portion where the notches 76 and 78 are positioned. As a result, in the fourth example embodiment as well, operation and effects similar to those in (1) and (2) in the first example embodiment are able to be displayed.

Next, example embodiments will be described. The flywheel is not limited to the structures illustrated in the first to the fifth example embodiments, and may be implemented in a mode that has been modified as appropriate, such as that described below, for example. Also, the modified examples described below may also be combined and applied to the example embodiments described above.

The inertia ring may be such that a thickness of at least one of a portion on the radially inner side that is a portion on the inner peripheral surface side or a portion on the radially outer side that is a portion on the outer peripheral surface side is relatively thinner than the other portions. By making the thickness of at least one of the portion on the radially inner side or the portion on the radially outer side thin in this way, and providing notches in the peripheral surface on the side with the portion that is provided thin (i.e., the inner peripheral surface or the outer peripheral surface), then when excessive stress is generated in the inertia ring due to circumferential force, this stress is able to be concentrated by the notches.

In the example embodiments described above, one or two insertion holes for bolts are provided in a portion of the inertia ring that is positioned between notches that are provided spaced apart in the circumferential direction. However, in the inertia ring, because there need only be at least one fastening portion that fastens the inertia ring to the flywheel in a portion positioned between notches provided spaced apart in the circumferential direction, there need only be one or more insertion hole for a bolt between the notches provided spaced apart in the circumferential direction. The number of insertion holes is not limited to the number illustrated above.

In the example embodiments described above, four or eight notches are provided in the circumferential direction, in at least one of the inner peripheral surface or the outer peripheral surface of the inertia ring. However, there need only be a plurality of notches provided in at least one of the inner peripheral surface or the outer peripheral surface of the inertia ring. The number of notches is not limited to the number illustrated in the example embodiments described above. Also, in the inertia ring, the number of bolt fastening portions that fasten the inertia ring to the flywheel main body may also simply be set such that there is at least one fastening portion at each portion of the inertia ring that is positioned between notches provided spaced apart in the circumferential direction, according to the number of notches provided in at least one of the inner peripheral surface or the outer peripheral surface of the inertia ring.

In the example embodiments described above, the notches have a wedge shape that becomes narrower farther away from the peripheral surface in which the notch is provided, but the shape of the notches is not limited to this. That is, the notches simply need to be able to control the fracturing of the inertia ring when excessive centrifugal force acts on the flywheel, so that the inertia ring fractures from the portion where the notches are provided. Therefore, the notches need simply be shaped so that stress tends to concentrate where they are provided. For example, the notches may have a shape in which the tensile strength of portions where notches that are adjacent in the circumferential direction of the inertia ring and that are positioned on both sides of a portion that is positioned between the notches, is less than the tensile strength of the portion positioned between the notches that are adjacent in the circumferential direction of the inertia ring.

The specific structures of the flywheel and the inertia ring are not limited to the shapes illustrated above. For example, in the example embodiments described above, the insertion holes for bolts that fasten the inertia ring to the flywheel main body do not pass through the inertia ring in the thickness direction, but the bolt insertion holes in the inertia ring may pass through the inertia ring. In this case, in the example embodiments described above, the bolts are first inserted through the second through-holes in the flywheel main body and then screwed into the insertion holes in the inertia ring, but the manner in which the inertia wheel is fastened to the flywheel is not limited to this. For example, a structure may be employed in which the bolts may be inserted through the second through-holes in the flywheel main body and the insertion holes in the inertia ring, in this order, and then nuts may be fastened to the tip ends of the bolts that have passed through the inertia ring. Also, the bolts may be inserted into the insertion holes from the inertia ring side and passed through the insertion holes in the inertia ring and the second through-holes in the flywheel main body, in this order, and then fixed by nuts. Further, the fastening portion between the flywheel main body and the inertia ring may be formed by a fastener other than a bolt. Fastening may also be accomplished by welding or the like.

Also, a bolt through-hole for fastening a member such as a damper or fixing to a jig at the time of manufacture, or a recessed portion for freeing a member such as a damper for mounting a jig at the time of manufacture or the like may also be provided in the inertia ring and the flywheel main body.

In the example embodiments described above, the flywheel is fixed to the crankshaft, but the flywheel may also be mounted to a rotating body other than the crankshaft.

What is claimed is:

1. A flywheel comprising:
a flywheel main body that has a disc-like shape; and
an inertia ring that (i) has an annular shape, (ii) has a plurality of fastening portions, (iii) is fastened to the flywheel main body by the fastening portions, (iv) has a plurality of notches provided spaced apart in a circumferential direction of the inertia ring, in at least one of an inner peripheral surface or an outer peripheral surface of the inertia ring, and (v) has at least one of the fastening portions at each portion that is positioned between the notches.

2. The flywheel according to claim 1, wherein
each of the notches has a wedge shape that becomes narrower farther away from the peripheral surface in which the notch is provided.

3. The flywheel according to claim 1, wherein
a plurality of the notches are provided in each of the inner peripheral surface and the outer peripheral surface of the inertia ring; and
the notches provided in the inner peripheral surface of the inertia ring, and the notches provided in the outer peripheral surface of the inertia ring, are provided in pairs, with one of the notches provided in the inner peripheral surface and one of the notches provided in the outer peripheral surface making up one pair, and the two notches in each pair being in the same position in the circumferential direction of the inertia ring.

4. The flywheel according to claim 1, wherein
a plurality of the notches are provided in each of the inner peripheral surface and the outer peripheral surface of the inertia ring; and
the notches provided in the inner peripheral surface of the inertia ring, and the notches provided in the outer peripheral surface of the inertia ring, are provided appearing alternately in the circumferential direction of the inertia ring.
